(19) United States
(12) Patent Application Publication
(10) Pub. No.: US 2023/0189273 A1
(43) Pub. Date: Jun. 15, 2023

(54) METHODS AND DEVICES FOR TRANSMITTING DATA AND CONTROL INFORMATION

(71) Applicant: SAMSUNG ELECTRONICS CO., LTD., Suwon-si, Gyeonggi-do (KR)

(72) Inventors: Jingxing FU, Suwon-si (CN); Feifei SUN, Beijing (CN); Yi WANG, Beijing (CN); Sa ZHANG, Beijing (CN)

(21) Appl. No.: 17/999,316

(22) PCT Filed: May 21, 2021
(86) PCT No.: PCT/KR2021/006372

§ 371 Date: Nov. 18, 2022

(30) Foreign Application Priority Data
May 22, 2020 (CN) 202010444230.2
Aug. 3, 2020 (CN) 202010769443.2
Sep. 21, 2020 (CN) 202010996072.1

(51) Int. Cl. H04W 72/21; H04W 72/56

(52) U.S. Cl. CPC H04W 72/21; H04W 72/56

(57) ABSTRACT

The present disclosure relates to a communication method and system for converging a 5th-Generation (5G) communication system for supporting higher data rates beyond a 4th-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. There is provided a method and device for transmitting. The method includes: receiving a multiplexing indication signal indicating multiplexing uplink control information (UCI) on a physical uplink shared channel (PUSCH); multiplexing the UCI on the PUSCH; and transmitting the multiplexed PUSCH, wherein the number of priorities of UCI multiplexed on one PUSCH is at least one.

### CROSS-REFERENCE TO RELATED APPLICATIONS

This application is a 371 of International Application No. PCT/KR2021/006372 filed May 21, 2021, which claims priority to Chinese Patent Application No. 202010444230.2, filed May 22, 2020, Chinese Patent Application No. 202010769443.2, filed Aug. 3, 2020, and Chinese Patent Application No. 202010996072.1, filed Sep. 21, 2020, the disclosures of which are herein incorporated by reference in their entirety.

### BACKGROUND

### Field

The present disclosure relates to a field of wireless communication technology, and more particularly, to a method and device for transmitting data and control information.

### Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (M-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COM), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things, IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### SUMMARY

In the New Radio (NR) system, User Equipment (UE) may simultaneously transmit uplink data with different priorities in one serving cell, or the UE may simultaneously transmit uplink data with different priorities in different serving cells. For example, the UE may simultaneously transmit low-priority Enhanced Mobile Broadband (eMBB) data and high-priority. Ultra Reliability Low Latency Communication (URLLC) data. In addition, the UE will also transmit uplink control information (UCI) with different priorities, for example, high-priority UCI related to high-priority URLLC and low-priority UCI related to low-priority eMBB. Among them, UCI may include hybrid automatic repeat reQuest-Acknowledgement (HARQ-ACK), channel state information (CSI) and scheduling request (SR), etc.

According to one aspect of embodiments of the present disclosure, there is provided a method for transmitting, including: receiving a multiplexing indication signal indicating multiplexing uplink control information (UCI) on a physical uplink shared channel (PUSCH); multiplexing the UCI on the PUSCH; and transmitting the multiplexed PUSCH, wherein a number of priorities of UCI multiplexed on one PUSCH is at least one.

In one example, the number of priorities of multiplexed on one PUSCH is one, and the priority of UCI is the same as or different from the priority of PUSCH.

In one example, multiplexing UCI with data includes: on each of the multiple PUSCHs with different priorities, multiplexing UCI with the same priority, respectively.

In one example, the number of priorities of UCI multiplexed on one PUSCH is more than one, and the priority of UCI is the same as or different from the priority of the PUSCH.

In one example, multiplexing UCI on the PUSCH includes: when at least two physical uplink control channels (PUSCH) that transmit UCI with different priorities simultaneously overlap with PUSCH, preferentially multiplexing UCI with higher priority among different priorities on PUSCH.

In one example, multiplexing UCI on the PUSCH further includes: multiplexing UCIs with different priorities on multiple PUSCHs with the same priority, respectively; and preferentially multiplexing UCI on PUSCHs with the same priority as that of the UCI.

In one example, the PUSCH on which the UCI is to be multiplexed is selected from multiple PUSCHs according to a predetermined rule.

In one example, when the multiplexed PUSCH is transmitted, a transmission power of the PUSCH, on which the UCI is multiplexed, is allocated decreasingly according to a decreasing order of the priorities of UCIs.

In one example, when UCIs with more than one priority are multiplexed on one PUSCH, the number and location of resources on PUSCH occupied by UCIs are determined in sequence according to the priority of UCI by the order from high to low.

In one example, when the UCI with a second priority is multiplexed on the PUSCH with a first priority, the position for transmitting data on the PUSCH with the second priority is determined preferentially, wherein the first priority is higher than the second priority.

In one example, multiplexing the UCI on the PUSCH includes: when the UCI with the first priority is multiplexed on the PUSCH with the second priority, multiplexing UCI with the first priority without being restricted by a resource threshold on the PUSCH with the second priority, the resource threshold is preset by protocols or determined by higher-layer signaling configurations; or when the UCI with the first priority is multiplexed on the PUSCH with the second priority, the physical uplink control channel (PUSCH) is used to transmit the UCI with the first priority, if required resources exceed the resource threshold on the PUSCH with the second priority (the resource threshold is preset by the protocol or determined by higher-layer signaling configuration), wherein the first priority is higher than the second priority.

In one example, a maximum number of resources on the PUSCH occupied by the UCI is preset.

In one example, the preset maximum number of resources on the PUSCH occupied by UCI includes at least one of: the total maximum number of resources on the PUSCH occupied by all UCIs; and the maximum number of resources on the PUSCH occupied by each UCI.

In one example, the multiplexing indication signal is higher-layer signaling or physical layer signaling, and also indicates whether to multiplex UCI on a PUSCH with a priority, different from that of the UCI.

In one example, the multiplexing indication signal indicates at least one of: whether the UCI with the first priority can be multiplexed on the PUSCH with the second priority; whether the UCI with the second priority can be multiplexed on the PUSCH with the first priority; and whether the UCI with the first priority can be multiplexed on the PUSCH with the second priority, while the UCI with the second priority can be multiplexed on the PUSCH with the first priority simultaneously, wherein the first priority is higher than the second priority.

According to another aspect of the embodiments of the present disclosure, there is provided a device for transmitting, including: a transceiver, transmitting and receiving signals; a processor; and a memory, in which instructions executable by the processor are stored, when being executed by the processor, the instructions cause the processor to execute the foregoing method.

According to the embodiments of the present disclosure, it can be ensured that the data and control information of the high-priority URLLC can be transmitted in time, and the impact of the transmitting data and control information of the high-priority URLLC on the data and control information of the low-priority eMBB can be reduced.

### BRIEF DESCRIPTION OF THE DRAWINGS

The present disclosure will be more readily understood through the following detailed description with the aid of the accompanying drawings, wherein the same reference numerals designate units of the same structure, and in which:

FIG. 1 shows an example wireless network according to various embodiments of the present disclosure;

FIG. 2a shows example wireless transmission and reception paths according to the present disclosure;

FIG. 2b shows example wireless transmission and reception paths according to the present disclosure;

FIG. 3a shows an example UE according to the present disclosure;

FIG. 3b shows an example gNB according to the present disclosure;

FIG. 4 shows a schematic diagram of multiplexing and transmitting UCI on PUSCH according to an embodiment of the present disclosure;

FIG. 5 shows a schematic flowchart of a method for transmitting data and control information according to an embodiment of the present disclosure;

FIG. 6 shows a schematic diagram of transmitting data and control signals according to Example 1 of the first embodiment of the present disclosure;

FIG. 7 shows a schematic diagram of transmitting data and control signals according to Example 2 of the first embodiment of the present disclosure;

FIG. 8 shows a schematic diagram of transmitting data and control signals according to Example 3 of the first embodiment of the present disclosure;

FIG. 9 shows a schematic diagram of transmitting data and control signals according to Example 4 of the first embodiment of the present disclosure;

FIG. 10 shows a schematic diagram of transmitting data and control signals according to Example 5 of the first embodiment of the present disclosure;

FIG. 11 shows a schematic diagram of transmitting data and control signals according to Example 1 of the second embodiment of the present disclosure;

FIG. 12 shows a schematic diagram of transmitting data and control signals according to Example 2 of the second embodiment of the present disclosure;

FIG. 13 shows a schematic flowchart of a method for allocating resources on PUSCH according to an embodiment of the present disclosure;

FIG. 14 shows a schematic diagram of resources allocated on PUSCH in the method of FIG. 13 according to an embodiment of the present disclosure;

FIG. 15 shows a schematic flowchart of another method for allocating resources on PUSCH according to an embodiment of the present disclosure;

FIG. 16 shows a schematic diagram of resources allocated on PUSCH in the method of FIG. 15 according to an embodiment of the present disclosure; and

FIG. 17 shows a schematic block diagram of a device for transmitting data and control information according to an embodiment of the present disclosure.

### DETAILED DESCRIPTION

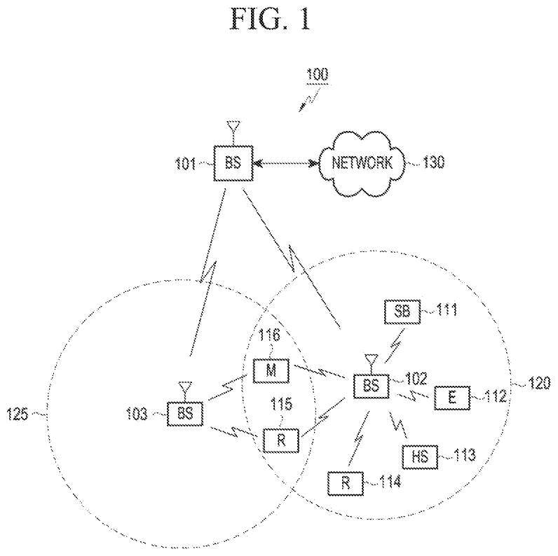

FIG. 1 illustrates an example wireless network 100 according to various embodiments of the present disclosure. The embodiment of the wireless network shown in FIG. 1 is for illustration only. Other embodiments of the wireless network 100 could be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one internet protocol (IP) network 130, such as the Internet, a proprietary Internet Protocol network, or other data network.

Depending on the network type, other well-known terms such as “base station” or “access point” can be used instead of “gNodeB” or “gNB”. For convenience, the terms “gNodeB” and “gNB” are used in this patent document to refer to network infrastructure components that provide wireless access to remote terminals. Also, depending on the network type, other well-known terms such as “mobile station”, “user station”, “remote terminal”, “wireless terminal” or “user device” can be used instead of “user equipment” or “UE”. For convenience, the terms “user equipment” and “UE” are used in this patent document to refer to a remote wireless device that wirelessly accesses the gNB, whether the UE is a mobile device (such as a mobile telephone or smartphone) or is normally considered a stationary device (such as a desktop computer or vending machine).

The gNB 102 provides wireless broadband access to the network 130 for a first plurality of user equipments (UEs) within a coverage area 120 of the gNB 102. The first plurality of LTEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G. Long Term Evolution (LTE), LTE-A, WiMAX, WiFi, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of gNB 101, gNB 102, and gNB 103 include a 2D antenna array as described in the embodiments of the present disclosure. In some embodiments, one or more of gNB 101, gNB 102, and gNB 103 supports codebook design and structure for systems with 2D antenna arrays.

Although FIG. 1 illustrates one example of a wireless network 100, various changes may be made to FIG. 1. For example, the wireless network could include any number of gNBs and any number of UEs in any suitable arrangement. Also, the eNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the eNBs 101, 102, and/or 103 could provide access to other or additional external networks, such as external telephone networks or other types of data networks.

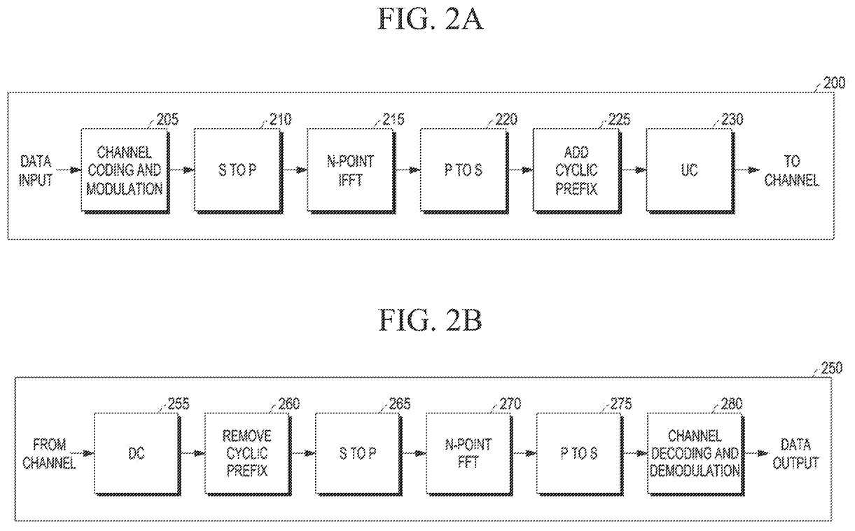

FIGS. 2a and 2b show example wireless transmission and reception paths according to the present disclosure. In the following description, the transmission path 200 can be described as being implemented in a gNB (such as gNB 102), and the reception path 250 can be described as being implemented in a LTE (such as UE 116). However, it should be understood that the reception path 250 can be implemented in a gNB, and the transmission path 200 can be implemented in a UE. In some embodiments, the reception path 250 is configured to support the codebook design and structure for a system with a 2D antenna array as described in the embodiments of the present disclosure.

The transmission path 200 includes a channel coding and modulation block 205, a serial-to-parallel (S-to-P) block 210, a N-point Inverse Fast Fourier Transform (IFFT) block 215, a parallel-to-serial (P-to-S) block 220, an ‘add cyclic prefix’ block 225, and an up-converter (UC) 230. The reception path 250 includes a down-converter (DC) 255, a ‘remove cyclic prefix’ block 260, a serial-to-parallel (S-to-P) block 265, a N-point Fast Fourier Transform (ITT) block 270, a parallel-to-serial (P-to-S) block 275, and a channel decoding and demodulation block 280.

In the transmission path 200, the channel coding and modulation block 205 receives a set of information bits, applies coding (such as low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The S-to-P block 210 converts (such as de-multiplexes) the serial modulated symbols to parallel data in order to generate N parallel symbol streams, where N is the number of IFFT/FFT points used in the gNB 102 and the UE 116. The N-point IFFT block 215 performs an IFFT operation on the N parallel symbol streams to generate time-domain output signals. The P-to-S block 220 converts (such as multiplexes) the parallel time-domain output symbols from the N-point IFFT block 215 in order to generate a serial time-domain signal. The ‘add cyclic prefix’ block 225 inserts a cyclic prefix to the time-domain signal. The UC 230 modulates (such as up-converts) the output of the ‘add cyclic prefix’ block 225 to an RF frequency for transmission via a wireless channel. The signal can also be filtered at baseband before conversion to the RF frequency.

A RF signal transmitted from the gNB 102 arrives at the UE 116 after passing through the wireless channel, and reverse operations to those at the gNB 102 are performed at the UE 116. The DC 255 down-converts the received signal to a baseband frequency, and the ‘remove cyclic prefix’ block 260 removes the cyclic prefix to generate a serial time-domain baseband signal. The serial-to-parallel block 265 converts the time-domain baseband signal to parallel time domain signals. The N-point FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 can implement a transmission path 200 that is analogous to transmitting in the downlink to UEs 111-116 and can implement a reception path 250 that is analogous to receiving in the uplink from UEs 111-116. Similarly, each of UEs 111-116 can implement a transmission path 200 for transmitting in the uplink to gNBs 101-103 and can implement a reception path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B can be implemented in software, while other components can be implemented by configurable hardware or a mixture of software and configurable hardware. For instance, the FFT block 270 and the IFFT block 215 can be implemented as configurable software algorithms, where the value of the number of point N can be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, could be used. It will be appreciated that the value of the variable N can be any integer number (such as 1, 2, 3, 4, or the like) for DFT and IDFT functions, while the value of the variable N can be any integer number that is a power of two (such as 1, 2, 4, 8, 16, or the like) for FFT and IFFT functions.

Although FIGS. 2A and 2B illustrate examples of wireless transmission and reception paths, various changes can be made to FIGS. 2A and 2B. For example, various components in FIGS. 2A and 2B could be combined, further subdivided, or omitted and additional components could be added according to particular needs. Also, FIGS. 2A and 2B are meant to illustrate examples of the types of transmission and reception paths that could be used in a wireless network. Other suitable architectures could be used to support wireless communications in a wireless network.

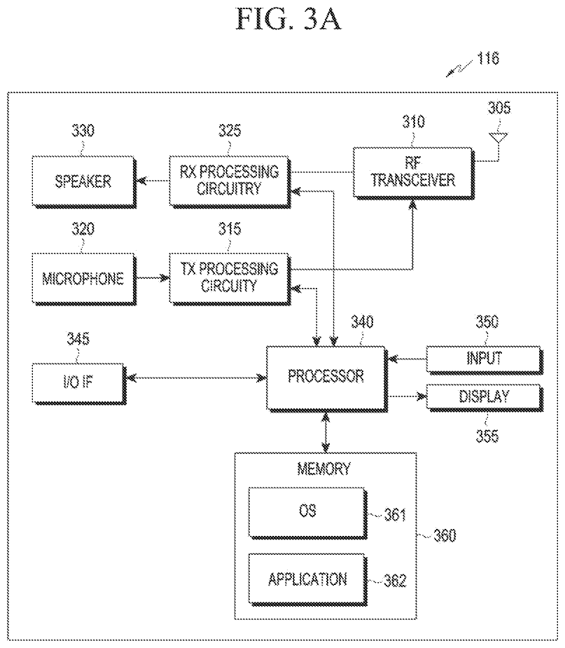

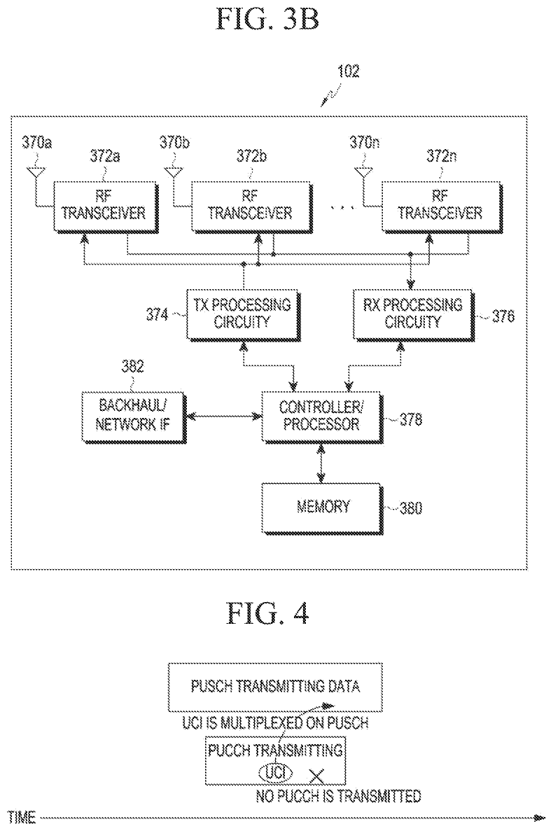

FIG. 3A illustrates an example UE 116 according to the present disclosure. The embodiment of the UE 116 illustrated in FIG. 3A is for illustration only, and the UEs 111-115 of FIG. 1 could have the same or similar configuration. However, UEs comes in a wide variety of configurations, and FIG. 3A does not limit the scope of the present disclosure to any particular implementation of a LIE

The UE 116 includes an antenna 305, a radio frequency (RF) transceiver 310, transmit (TX) processing circuitry 315, a microphone 320, and receive (RX) processing circuitry 325. The UE 116 also includes a speaker 330, a processor/controller 340, an input/output (I/O) interface 345, an input device(s) 350, a display 355, and a memory 360. The memory 360 includes an operating system (OS) program 361 and one or more applications 362.

The RF transceiver 310 receives, from the antenna 305, an incoming RF signal transmitted by a gNB of the wireless network 100. The RF transceiver 310 down-converts the incoming RF signal to generate an intermediate frequency (IF) or baseband signal. The IF or baseband signal is sent to the RX processing circuitry 325, wherein the RX processing circuitry 325 generates a processed baseband signal by filtering, decoding, and/or digitizing the baseband or IF signal. The RX processing circuitry 325 transmits the processed baseband signal to the speaker 330 (such as for voice data) or to the processor/controller 340 for further processing (such as for web browsing data).

The TX processing circuitry 315 receives analog or digital voice data from the microphone 320 or other outgoing baseband data (such as web data, e-mail, or interactive video game data) from the processor/controller 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor/controller 340 can include one or more processors or other processing devices and execute the OS 361 stored in the memory 360 in order to control the overall operation of the UE 116. For example, processor/controller 340 could control the reception of forward channel signals and the transmission of reverse channel signals by the RF transceiver 310, the RX processing circuitry 325, and the TX processing circuitry 315 in accordance with well-known principles. In some embodiments, the processor/controller 340 includes at least one microprocessor or microcontroller.

The processor/controller 340 is also capable of executing other processes and programs resident in the memory 360, such as operations for channel quality measurement and reporting for systems with 2D antenna array as described in embodiments of the present disclosure. The processor/controller 340 can move data into or out of the memory 360 as required by an executing process. In some embodiments, the processor/controller 340 is configured to execute the applications 362 based on the OS 361 or in response to signals received from gNBs or an operator. The processor/controller 340 is also coupled to the I/O interface 345, wherein the I/O interface 345 provides the UE 116 with the ability to connect to other devices such as laptop computers and handheld computers. The I/O interface 345 is the communication path between these accessories and the processor/controller 340.

The processor/controller 340 is also coupled to the input device(s) 350 and the display 355. The operator of the UE 116 can use the input device(s) 350 to enter data into the LE 116. The display 355 can be a liquid crystal display or other display capable of rendering text and/or at least limited graphics, such as from web sites. The memory 360 is coupled to the processor/controller 340. Part of the memory 360 could include a random access memory (RAM), and another part of the memory 360 could include a Flash memory or other read-only memory (ROM).

Although FIG. 3A illustrates one example of UE 116, various changes can be made to FIG. 3A. For example, various components in FIG. 3A could be combined, further subdivided, or omitted and additional components could be added according to particular needs. As a particular example, the processor/controller 340 could be divided into multiple processors, such as one or more central processing units (CPUs) and one or more graphics processing units (GPUs). Also, while FIG. 3A illustrates the UE 116 configured as a mobile telephone or smartphone, UEs could be configured to operate as other types of mobile or stationary devices.

FIG. 3B illustrates an example gNB 102 according to the present disclosure. The embodiment of the gNB 102 shown in FIG. 3B is for illustration only, and other gNBs of FIG. 1 could have the same or similar configuration. However, gNBs come in a wide variety of configurations, and FIG. 3B does not limit the scope of the present disclosure to any particular implementation of a gNB. It should be noted, the gNB 101 and the gNB 103 can include the same or similar structure as the gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, wherein the RX processing circuitry 376 generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of forward channel signals and the transmission of reverse channel signals by the RF transceivers 372a-372n, the RX processing circuitry 376, and the TX processing circuitry 374 in accordance with well-known principles. The controller/processor 378 could support additional functions as well, such as more advanced wireless communication functions. For example, the controller/processor 378 can perform a blind interference sensing (BIS) process such as performed by a BIS algorithm, and decode the received signal from which the interference signal is subtracted. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems with 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The backhaul or network interface 382 could support communications over any suitable wired or wireless connection(s). For example, when the gNB 102 is implemented as part of a cellular communication system (such as one cellular communication system supporting 5G or new radio access technology or NR, LTE, or LTE-A), the backhaul or network interface 382 could allow the gNB 102 to communicate with other gNBs over a wired or wireless backhaul connection. When the gNB 102 is implemented as an access point, the backhaul or network interface 382 could allow the gNB 102 to communicate over a wired or wireless local area network or over a wired or wireless connection to a larger network (such as the Internet). The backhaul or network interface 382 includes any suitable structure supporting communications over a wired or wireless connection, such as an Ethernet or RF transceiver.

The memory 380 is coupled to the controller/processor 378. Part of the memory 380 could include a RAM, and another part of the memory 380 could include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmission and reception paths of the gNB 102 (implemented using the RF transceivers 372a-372n, TX processing circuitry 374, and/or RX processing circuitry 376) support aggregated communication with FDD cells and TDD cells.

Although FIG. 3B illustrates one example of a gNB 102, various changes can be made to FIG. 3B. For example, the gNB 102 could include any number of each component shown in FIG. 3A. As a particular example, an access point could include a number of backhaul or network interfaces 382, and the controller/processor 378 could support routing functions to route data between different network addresses. As another particular example, while shown as including a single instance of TX processing circuitry 374 and a single instance of RX processing circuitry 376, the gNB 102 could include multiple instances of each (such as one for each RF transceiver).

The exemplary embodiments of the present disclosure are further described below in conjunction with the accompanying drawings.

The text and drawings are provided as examples only to help readers understand the present disclosure. They are not intended to and should not be interpreted as limiting the scope of the present disclosure in any way. Although certain embodiments and examples have been provided, based on the content disclosed herein, it is apparent to those skilled in the art that the illustrated embodiments and examples can be modified without departing from the scope of the present disclosure.

There are physical uplink shared channels (PUSCHs) for transmitting data and UCI with high-priority, and physical uplink control channels (PUCCHs) for transmitting UCI with high-priority; as well as PUSCHs for transmitting data and UCI with low-priority, and PUCCHs for transmitting UCI with low-priority.

For example, in the case that there are two priorities, the PUTSCH for transmitting data and UCI with high-priority can be referred as PUSCH with a first priority, the PUCCH for transmitting UCI with high-priority can be referred as PUCCH with the first priority, and the high-priority UCI can be referred as UCI with the first priority. In addition, the PUTSCH for transmitting data and UCI with low-priority can be referred as PUSCH with a second priority, the PUCCH for transmitting UCI with low-priority can be referred as PUCCH with the second priority, and the low-priority UCI can be referred as UCI with the second priority. The priority of the PUSCH with the first priority is higher than the priority of the PUSCH with the second priority, and the priority of the UCI with the first priority is higher than the priority of UCI with the second priority. PUSCH with the first priority (also known as high-priority PUSCH), PUCCH with the first priority (also known as high-priority PUCCH) and UCI with the first priority (also known as high-priority UCI) are referred as PUSCH, PUCCH and UCI with the same priority (the first priority). PUSCH with the second priority (also known as low-priority PUSCH), PUCCH with the second priority (also known as low-priority PUCCH) and UCI with the second priority (also known as low-priority UCI) are referred as PUSCH, PUCCH and UCI with the same priority (the second priority).

In a system where multiple uplink serving cells are configured, each uplink serving cell can transmit high-priority PUSCH, PUCCH and UCI as well as low-priority PUSCH, PUCCH and UCI.

According to the embodiment of the present disclosure, UCI can be transmitted on PUCCH, UCI can also be multiplexed on PUSCH for transmitting data and transmitted together with the data.

FIG. 4 shows a schematic diagram of multiplexing and transmitting UCI on PUSCH according to an embodiment of the present disclosure.

As shown in FIG. 4, when the PUCCH for transmitting UCI and the PUSCH for transmitting data overlap in time, the UCI originally transmitted on the PUCCH can be multiplexed on the PUSCH, yet the PUCCH is no longer transmitted.

FIG. 5 shows a schematic flowchart of a method 500 for transmitting according to an embodiment of the present disclosure. For example, the method 500 can be performed on the user equipment (UE) end.

Referring to FIG. 5, at step S501, a multiplexing indication signal indicating multiplexing uplink control information (UCI) on a physical uplink shared channel (PUSCH) is received. At step S502, the UCI is multiplexed on the PUSCH. At step S503, the multiplexed PUSCH is transmitted, wherein a number of priorities of UCI multiplexed on one PUSCH is at least one.

According to the embodiment of the present disclosure, the number of priorities of UCI multiplexed on PUSCH may be one or more, and the priority of the PUSCH may be the same as or different from the priority of the UCI, which can increase a flexibility of multiplexing UCIs.

In one example, the multiplexing indication signal can be higher-layer signaling or physical layer signaling, and the physical layer signaling refers to information in Downlink Control Information (DCI), which will not be repeated hereinafter.

In addition, according to the embodiment of the present disclosure, the multiplexing indication signal may also indicate whether UCI can be multiplexed on a PUSCH with a priority different from the priority of UCI. However, the embodiment of the present disclosure is not limited to this; and one separate signaling can also be used to indicate whether UCI can be multiplexed on a PUSCH with a priority different from the priority of UCI, and the signaling can be the higher-layer signaling or the physical layer signaling.

Indicating whether UCI can be multiplexed on a PUSCH with a priority different from the priority of UCI through multiplexing indication signal or separate signaling includes: whether the high-priority UCI can be multiplexed on the low-priority PUSCH; whether the low-priority UCI can be multiplexed on the high-priority PUSCH; and whether the high-priority UCI can be multiplexed on the low-priority PUSCH while the low-priority UCI can be multiplexed on the high-priority PUSCH simultaneously. For example, in the case that there are two priorities for both UCI and PUSCH respectively, indicating whether UCI can be multiplexed on PUSCH with a priority different from the priority of UCI through multiplexing indication signal or separate signaling includes: whether UCI with a first priority can be multiplexed on PUSCH with a second priority; whether UCI with a second priority can be multiplexed on PUSCH with a first priority; and UCI with the first priority can be multiplexed on PUSCH with the second priority while UCI with the second priority can be multiplexed on PUSCH with the first priority simultaneously.

By indicating whether UCI can be multiplexed on PUSCH with the priority different from the priority of UCI through the multiplexing indication signal or the separate signaling, the flexibility of multiplexing UCIs can be further increased.

It may indicate the number N of priorities of UCI that can be multiplexed on all the PUSCHs with respective priorities, where N is a positive integer. N may be configured by the higher-layer signaling, determined by the physical layer signaling indication, or determined by the protocol. For example, according to the protocol, N may be determined to be equal to 1.

For example, the number of priorities of UCIs that can be simultaneously multiplexed on each PUSCH is N. In the case of N=1, when the PUCCH transmitting the UCI with the first priority and the PUCCH transmitting the UCI with the second priority overlap in time with the PUSCH with the first priority, the UCI with the first priority is multiplexed on the PUSCH with the first priority and the UCI with the second priority is discarded. When the PUCCH transmitting the UCI with the first priority and the PUCCH transmitting the UCI with the second priority overlap in time with the PUSCH with the second priority, only the UCI with the first priority is multiplexed on the PUSCH with the first priority and the UCI with the second priority is discarded.

According to the embodiment of the present disclosure, by indicating the number of different priorities of UCI simultaneously multiplexed on one PUSCH, a performance of the PUSCH can be flexibly determined and a balance between the performance of the PUSCH and the performance of the UCI can be ensured.

In addition, the number of priorities of UCIs that can be multiplexed on PUSCHs of every priority can also be indicated, respectively. The same signaling can be used to indicate the number of priorities of the UCIs that can be multiplexed on the PUSCH for every priority, or multiple signaling can be used to indicate the number of priorities of the UCIs that can be multiplexed on the PUSCH for every priority, respectively.

For example, on each PUSCH with the first priority, the number of the priorities of UCIs that can be simultaneously is N_1, wherein N_1 is a positive integer, and N_1 can be configured by a higher-layer signaling, determined by indication of a physical layer signaling, or determined by a protocol. For example, according to the protocol, N_1 can be determined to be equal to 1. For example, when the PUCCH transmitting the UCI with the first priority and the PUCCH transmitting the UCI with the second priority overlap in time with the PUSCH with the first priority, the UCI with the first priority can be multiplexed on the PUSCH with the first priority, and the UCI with the second priority can be discarded. Alternatively, when only the PUCCH transmitting the UCI with the second priority overlaps in time with the PUSCH with the first priority, the UCI with the second priority can be multiplexed on the PUSCH with the first priority. By indicating the number of different priorities of UCIs simultaneously multiplexed on one high-priority PUSCH via signaling, the performance of the PUSCH can be flexibly determined and the balance between the performance of the PUSCH and the performance of the UCI can be ensured.

On each PUSCH with the second priority, the number of the priorities of UCIs that can be simultaneously is N_2, wherein N_2 is a positive integer, and N_2 can be configured by a higher-layer signaling, determined by indication of a physical layer signaling, or determined by a protocol. For example, according to the protocol, N_2 can be determined to be equal to 2. For example, when the PUSCH transmitting the UCI with the first priority and the PUCCH transmitting the UCI with the second priority overlap in time with the PUSCH with the second priority, the UCI with the first priority and the UCI with the second priority can be simultaneously multiplexed on the PUSCH with the second priority. By indicating the number of different priorities of UCIs simultaneously multiplexed on one low-priority PUSCH via signaling, the performance of the PUSCH can be flexibly determined and the balance between the performance of the PUSCH and the performance of the UCI can be ensured.

According to the embodiment of the present disclosure, by indicating the number of different priorities of UCIs on the low-priority PUSCH and the number of different priorities of UCIs on the high-priority PUSCH respectively, the performance of the PUSCH can be flexibly determined and the balance between the performance of the PUSCH and the performance of the UCI can be ensured respectively, in accordance with the priorities of the PUSCHs.

In addition, what has been described above is: the base station indicates to the UE the configuration of multiplexing the UCIs on PUSCH via signaling, meanwhile the UE can also report its capability of multiplexing the UCI to the base station. For example, the UE reports to the base station its capability that the number of the priorities of UCIs can be simultaneously multiplexed on each PUSCH with the first priority is N_1, and/or its capability that the number of the priorities of UCIs can be simultaneously multiplexed on each PUSCH with the second priority is N_2, etc.

Hereinafter, various embodiments according to the present disclosure will be described in detail with reference to the accompanying drawings. In the following description, a case wherein there are two priorities for all of the UCIs, PUSCH, and PUSCH is described as an example, but the embodiment of the present disclosure is not limited to this, and there may be more priorities, and the numbers of priorities of UCIs, PUSCH, and PUCCH can be different from each other.

### The First Embodiment

In the first embodiment according to the present disclosure, the number of the priorities of UCIs being multiplexed on one PUSCH is only one. The priority of the UCIs may be the same as or different from the priority of the PUSCH.

Principles of multiplexing UCIs are as follows.

Multiplexing Principle One

When user equipment (UE) transmits multiple PUSCHs that overlap in time in multiple serving cells, UCI is preferentially multiplexed on the PUSCH with the same priority as that of the UCI. That is, if there is a PUSCH with the same priority as that of the UCI overlapping with the PUCCH transmitting the UCI in time, the UCI is multiplexed on the PUSCH with the same priority as that of the UCI; if there is not a PUSCH with the same priority as that of the UCI overlapping with the PUCCH transmitting the UCI in time, the UCI is multiplexed on the PUSCH with a different priority from that of the UCI.

For example, when the PUCCH transmitting the UCI with the first priority overlaps with the PUSCH with the first priority and the PUSCH with the second priority in time, the UCI with the first priority is multiplexed on the PUSCH with the first priority. When the PUCCH transmitting the UCI with the first priority only overlaps with the PUSCH with the second priority in time and does not overlap with the PUSCH with the first priority, the UCI with the first priority, is multiplexed on the PUSCH with the second priority.

Multiplexing UCIs on PUSCH with the same priority as that of the UCIs can easily meet the delay requirements of multiplexing. In addition, multiplexing high-priority UCI on high-priority PUSCH can easily ensure the performance of high-priority UCI. Multiplexing the low-priority UCI on the low-priority PUSCH can minimize the impact on the performance of the high-priority PUSCH.

When there is no PUSCH with the same priority as that of the UCI overlapping with the PUCCH transmitting UCIs in time, multiplexing UCIs on a PUSCH with a different priority from that of the UCIs can minimize the impact on low-priority data and the UCIs.

Multiplexing Principle Two

UCIs with different priorities can be respectively multiplexed on multiple PUSCHs with the same priority as that of the UCI, and the number of the priorities of the UCI being multiplexed on each PUSCH is only one.

For example, when the PUCCH transmitting the UCI with the first priority and the PUCCH transmitting the UCI with the second priority overlap in time with PUSCH2-1 with the second priority and PUSCH2-2 with the second priority, the UCI with the first priority can be multiplexed on the PUSCH2-1 with the second priority and the UCI with second first priority, can be multiplexed on the PUSCH2-2 with the second priority, the number of the priorities of the UCI that can be multiplexed on each PUSCH is only one.

Alternatively, when the PUCCH transmitting the UCI with the first priority and the PUCCH transmitting the UCI with the second priority overlap in time with PUSCH1-1 with the first priority and PUSCH1-2 with the first priority, the UCI with the first priority can be multiplexed on the PUSCH1-1 with the first priority and the UCI with second first priority can be multiplexed on the PUSCH1-2 with the first priority.

According to the embodiment of the present disclosure, the number of the priorities of the UCI that can be multiplexed on one PUSCH is one, the number of resources for multiplexing UCI can be determined more accurately through the information in the DCI scheduling the PUSH, and the impact of multiplexing UCI on PUSCH performance can be reduced as much as possible.

Multiplexing Principle Three

When PUCCHs that transmit UCIs with different priorities simultaneously overlap with PUSCH, the high-priority UCI is preferentially multiplexed on the PUSCH.

For example, when the PUCCH transmitting the UCI with the first priority and the PUCCH transmitting the UCI with the second priority overlap in time with one PUSCH with the second priority, the UCI with the first priority is preferentially multiplexed on the PUSCH with the second priority PUSCH, and the UCI with the second priority is discarded. Preferentially multiplexing the high-priority UCI can minimize the impact on low-priority data as much as possible.

Hereinafter, various examples according to the first embodiment of the present disclosure will be described in more detail.

### Example 1.1

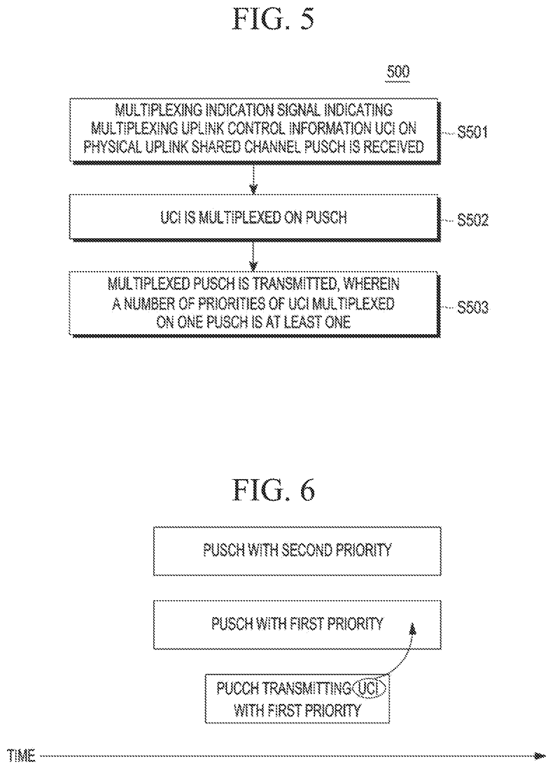

FIG. 6 shows a schematic diagram of transmitting data and control signals according to Example 1 of the first embodiment of the present disclosure.

When there is a transmission of UCI with a first priority, and there are PUSCH with the first priority and PUSCH with the second priority overlapping in time with the PUCCH transmitting the UCI with the first priority, the UCI with the first priority is multiplexed on the PUSCH with the first priority.

Therefore, the delay requirement of multiplexing can be easily met, and multiplexing the high-priority UCI on the high-priority PUSCH can easily ensure the performance of the high-priority UCI.

### Example 1.2

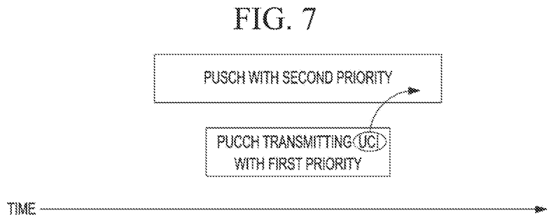

FIG. 7 shows a schematic diagram of transmitting data and control signals according to Example 2 of the first embodiment of the present disclosure.

When there is a transmission of UCI with the first priority, there is no PUSCH with the first priority overlapping in time with the PUCCH transmitting the UCI with the first priority, but there is PUSCH with the second priority overlapping in time with the PUCCH transmitting the UCI with the first priority, UCI with the first priority is multiplexed on the PUSCH with the second priority.

According to the embodiment of the present disclosure, by multiplexing the high-priority UCI on the low-priority PUSCH, it can minimize the impact on low-priority data as much as possible, otherwise the transmission of the low-priority PUSCH will be discarded.

Alternatively, when there is a transmission of UCI with the second priority, there is no PUSCH with the second priority overlapping in time with the PUCCH transmitting the UCI with the second priority, but there is PUSCH with the first priority overlapping in time with the PUCCH transmitting the UCI with the second priority, UCI with the second priority is multiplexed on the PUSCH with the first priority.

### Example 1.3

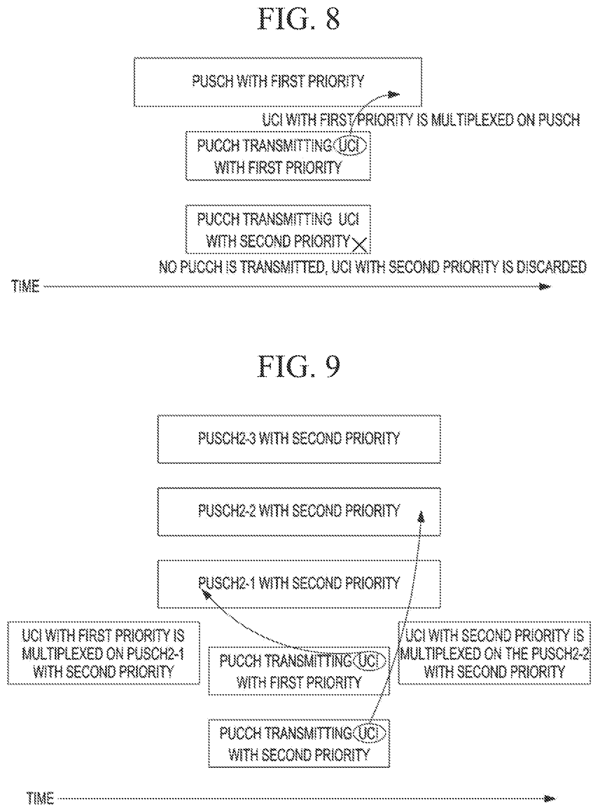

FIG. 8 shows a schematic diagram of transmitting data and control signals according to Example 3 of the first embodiment of the present disclosure.

If there are a transmission of UCI with the first priority and a transmission of UCI with the second priority at the same time, and there is PUSCH with the first priority simultaneously overlapping in time with the PUCCH transmitting UCI with the first priority and the PUCCH transmitting the UCI with the second priority, but there is no PUSCH with the second priority overlapping in time with the PUCCH transmitting UCI with the second priority, then the UCI with the first priority can be multiplexed on the PUSCH with the first priority, and the UCI with the second priority is not multiplexed on the PUSCH with the first priority. Moreover, because there is only one PUSCH transmission at this time and the number of the priorities of UCIs that can be multiplexed on each PUSCH is only one, the PUCCH that transmits the UCI with the second priority may not be transmitted any longer; and the UCI with the second priority is discarded.

Alternatively, if there are a transmission of UCI with the first priority and a transmission of UCI with the second priority at the same time, there is no PUSCH with the first priority overlapping in time with the PUCCH transmitting UCI with the first priority, and there is only one PUSCH with the second priority simultaneously overlapping in time with the PUCCH transmitting the UCI with the first priority and the PUCCH transmitting UCI with the second priority, then the UCI with the first priority is multiplexed on the PUSCH with the second priority, and the UCI with the second priority is not multiplexed on the PUSCH with the second priority. Moreover, because there is only one PUSCH transmission at this time and the number of the priorities of UCIs that can be multiplexed on each PUSCH is only one, the PUCCH that transmits the UCI with the second priority may not be transmitted any longer. At this time, by multiplexing the high-priority UCI on the low-priority PUSCH, it can minimize the impact on low-priority data as much as possible.

Otherwise, the low-priority PUSCH transmission and the low-priority UCI transmission will be simultaneously discarded.

### Example 1.4

FIG. 9 shows a schematic diagram of transmitting data and control signals according to Example 4 of the first embodiment of the present disclosure.

If there are a transmission of UCI with the first priority and a transmission of UCI with the second priority at the same time, there is no PUSCH with the first priority overlapping with the PUCCH transmitting UCI with the first priority, but there are more than one (for example, 3) PUSCHs with the second priority, that is, PUSCH2-1 with the second priority, PUSCH2-2 with the second priority and PUSCH2-3 with the second priority, simultaneously overlapping with the PUCCH transmitting the UCI with the first priority and the PUCCH transmitting UCI with the second priority, then at first, the PUSCH on which the UCI with the first priority is to be multiplexed is selected according to a predetermined rule. For example; the predetermined rule may include that the UCI is preferentially multiplexed on the PUSCH of the serving cell with a small index among the serving cells, that is, the UCI with the first priority is multiplexed on PUSCH2-1 with the second priority. Then, the PUSCH on which the UCI with the second priority is to be multiplexed is selected from among the remaining PUSCHs according to a predetermined rule. For example, from among the remaining PUSCHs, the UCI is preferentially multiplexed on the PUSCH of the serving cell with a small index among the serving cells, that is, the UCI with the second priority is multiplexed on PUSCH2-2 with the second priority.

As a result, the UCI with the first priority is multiplexed on PUSCH2-1 with the second priority, the UCI with the second priority is multiplexed on PUSCH2-2 with the second priority, there is no UCI being multiplexed on PUSCH2-3 with the second priority and the number of the priorities of UCIs multiplexed on each PUSCH is one. As such, the impact on low-priority data can be reduced.

In addition, when there is no PUSCH with the same priority as that of the UCI overlapping in time with the PUCCH transmitting the UCI, by multiplexing the UCI on the PUSCH with a different priority from that of the UCI, it can minimize the impact on low-priority data and UCI as much as possible.

### Example 1.5

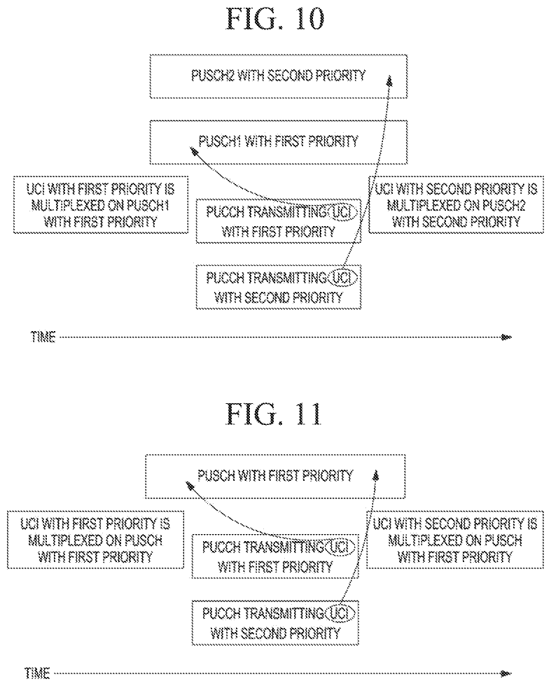

FIG. 10 shows a schematic diagram of transmitting data and control signals according to Example 5 of the first embodiment of the present disclosure.

If there are a transmission of UCI with the first priority and a transmission of UCI with the second priority at the same time, and there are PUSCH with the first priority and PUSCH2 with the second priority overlapping with the PUCCH transmitting UCI with the first priority and the PUCCH transmitting the UCI with the second priority, then at first, the PUSCH on which the UCI with the first priority is to be multiplexed is selected according to a predetermined rule. For example, the UCI is preferentially multiplexed on the PUSCH with the same priority as that of the UCI, that is, the UCI with the first priority is multiplexed on the PUSCH1 with the first priority. Then, the PUSCH on which the UCI with the second priority is to be multiplexed is selected from among the remaining PUSCHs according to a predetermined rule. For example, from among the remaining PUSCHs, the UCI is preferentially multiplexed on the PUSCH with the same priority as that of the UCI, that is, the UCI with the second priority is multiplexed on PUSCH2 with the second priority.

According to the embodiment of the present disclosure, by multiplexing UCI on the PUSCH with the same priority as that of the UCI, the delay requirement of multiplexing can be easily met. By multiplexing the high-priority UCI on the high-priority PUSCH, the performance of the high-priority UCI can be ensured, and by multiplexing the low-priority UCI on the low-priority PUSCH, the impact on the performance of the high-priority PUSCH can be reduced.

### Example 1.6

Although not shown in the figure, there may be another scenario.

For example, If there are a transmission of UCI with the first priority and a transmission of UCI with the second priority at the same time, there is no PUSCH with the second priority overlapping with the PUCCH transmitting UCI with the second priority, but there are more than one (for example, 3) PUSCHs with the first priority, that is, PUSCH1-1 with the first priority, PUSCH1-2 with the first priority and PUSCH1-3 with the first priority, simultaneously, overlapping in time with the PUCCH transmitting the UCI with the first priority and the PUCCH transmitting UCI with the second priority, then at first, the PUSCH on which the UCI with the first priority is to be multiplexed is selected according to a predetermined rule. For example, the UCI is preferentially multiplexed on the PUSCH of the serving cell with a small index among the serving cells, that is, the UCI with the first priority is multiplexed on PUSCH1-1 with the first priority. Then, the PUSCH on which the UCI with the second priority is to be multiplexed is selected from among the remaining PUSCHs according to a predetermined rule. For example, from among the remaining PUSCHs, the UCI is preferentially multiplexed on the PUSCH of the serving cell with a small index among the serving cells, that is, the UCI with the second priority is multiplexed on PUSCH1-2 with the first priority.

As a result, the UCI with the first priority is multiplexed on PUSCH1-1 with the first priority, the UCI with the second priority is multiplexed on PUSCH1-2 with the first priority, there is no UCI being multiplexed on PUSCH1-3 with the first priority and the number of the priorities of UCIs multiplexed on each PUSCH is one. As such, the impact on low-priority data can be reduced.

### Example 1.7

Although not shown in the figure, there may be still another scenario.

Similar to Example 1.3, if there are a transmission of UCI with the first priority and a transmission of UCI with the second priority at the same time, there is no PUSCH with the second priority overlapping in time with the PUCCH transmitting UCI with the second priority, and there is only one PUSCH with the first priority simultaneously overlapping in time with the PUCCH transmitting the UCI with the first priority and the PUSCH transmitting UCI with the second priority, then at first, the PUSCH on which the UCI with the first priority is to be multiplexed is selected according to a predetermined rule. For example, the UCI is preferentially multiplexed on the PUSCH of the serving cell with a small index among the serving cells, that is, the UCI with the first priority is multiplexed on PUSCH with the second priority. Then, if there is no remaining PUSCH, the UCI with the second priority will not be multiplexed.

By multiplexing the UCI with the first priority on the PUSCH with the first priority, the transmission of the high-priority PUSCH and the high-priority UCI can be ensured.

In addition, if there is only PUSCH with the second priority, the UCI with the first priority can also be multiplexed on the PUSCH with the second priority according to different predetermined rules. Then, if there is no remaining PUSCH, the with the second priority will not be multiplexed.

When UCIs with different priorities are multiplexed on different PUSCHs each with the same priority as that of the UCIs, the transmission power of the PUSCH, on which the UCI is multiplexed, is allocated decreasingly according to the decreasing order of the priorities of UCIs. For example, the transmission power of the PUSCH may be allocated through higher-layer signaling, physical layer signaling or a protocol, or be notified by the base station using a separate signal as well.

In particular, the priority of power allocation of the PUSCH on which the UCI with the first priority is multiplexed is higher than that of the PUSCH on which the UCI with the first priority is multiplexed, and the priority of power allocation of the PUSCH on which the UCI with the second priority is multiplexed is higher than that of the PUSCH on which no UCI is multiplexed.

For example, when the UE simultaneously transmits 3 PUSCHs with the same priority, that is PUSCH-1, PUSCH-2 and PUSCH-3, wherein the UCI with the first priority is multiplexed on PUSCH-1, the UCI with the second priority is multiplexed on PUSCH-2, and there is no UCI being multiplexed on PUSCH-3. When the total power required by the UE to transmit 3 PUSCHs is greater than the maximum allowable power for the UE, the priority of power allocation of PUSCH-1 is greater than that of PUSCH-2, and the priority of power allocation of PUSCH-2 greater than that of PUSCH-3. Therefore, the performance of high-priority UCI can be ensured preferentially.

When on one PUSCH, the UCI with different priority from that of the PUSCH is multiplexed, a number of types of UCI can be limited in advance. Here, the types of UCI may include, but are not limited to, HARQ-ACK, CSI, and SR, and may also include other types of UCI. The maximum number (M) of types of UCI multiplexed on one PUSCH can be determined through signaling indication (for example, higher-layer signaling configuration or physical layer signaling indication) or protocol presets, wherein M is a positive integer. For example, when low-priority UCI is multiplexed on a high-priority PUSCH, the maximum number (M_1) of types of UCI multiplexed on one PUSCH is determined through signaling indication (for example, higher-layer signaling configuration or physical layer signaling indication) or protocol presets, wherein M_1 is a positive integer, for example, M_1 is equal to 1. When the UCI with the second priority, is multiplexed on the PUSCH with the first priority, the with the second priority can only be HARQ-ACK.

### Second Embodiment

In the second embodiment according to the present disclosure, the number of the priorities of UCIs can be multiplexed on one PUSCH is more than one. The priority of the UCIs may be the same as or different from the priority of the PUSCH.

The principles of multiplexing UCIs are as follows.

Multiplexing Principle One

When the UE transmits multiple PUSCHs overlapping in time in more than one serving cell, the UCI is preferentially multiplexed on the PUSCH with the same priority as that of the UCI.

Multiplexing Principle Two

When the UE transmits multiple PUSCHs overlapping in time in more than one serving cell, UCIs with different priorities are preferentially multiplexed on different PUSCHs respectively, that is, the number of the priorities of the UCI multiplexed on each PUSCH should be one, if possible; when the UE only transmits one PUSCH overlapping in time in a serving cell and the number of the priority of UCI is more than one, the number of the priority of UCI multiplexed on each PUSCH is more than one; or when UE transmits more than one PUSCHs with the same priority overlapped in time in more than one serving cells and the number of the priority, of UCI is more than one, the number of the priority of UCI multiplexed on one PUSCH is more than one.

Hereinafter, various examples according to the second embodiment of the present disclosure will be described in more detail.

### Example 2.1

FIG. 11 shows a schematic diagram of transmitting data and control signals according to Example 1 of the second embodiment of the present disclosure.

If there are a transmission of UCI with the first priority and a transmission of UCI with the second priority at the same time, there is no PUSCH with the second priority overlapping in time with the PUCCH transmitting UCI with the second priority, and there is only one PUSCH with the first priority simultaneously overlapping in time with the PUCCH transmitting the UCI with the first priority and the PUCCH transmitting UCI with the second priority, then the UCI with the first priority and the UCI with the second priority is multiplexed on the PUSCH with the first priority.

By multiplexing the UCI with the first priority and the UCI with the second priority on the PUSCH with the first priority, the transmission of the high-priority PUSCH and the high-priority UCI as well as the transmission of the low-priority UCI can be ensured.

### Example 2.2

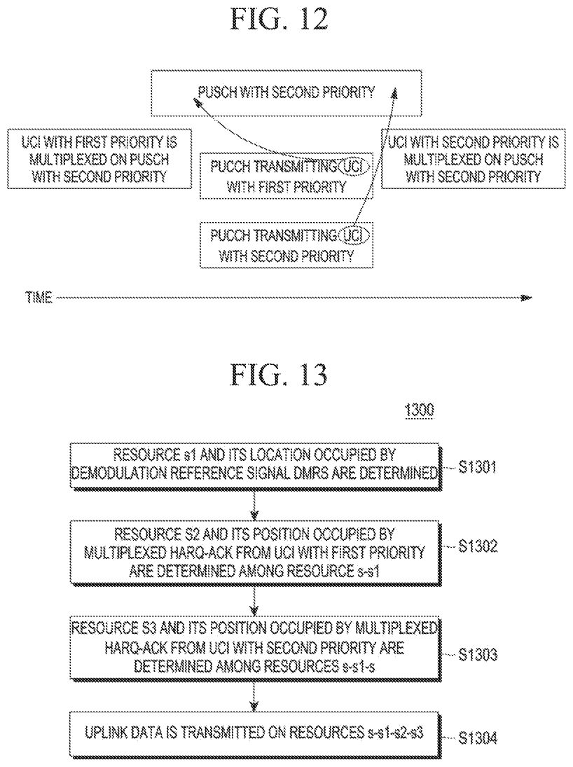

FIG. 12 shows a schematic diagram of transmitting data and control signals according to Example 2 of the second embodiment of the present disclosure.

If there are a transmission of UCI with the first priority and a transmission of UCI with the second priority at the same time, there is no PUSCH with the first priority overlapping in time with the PUCCH transmitting UCI with the first priority, and there is only one PUSCH with the second priority simultaneously overlapping in time with the PUCCH transmitting the UCI with the first priority and the PUCCH transmitting UCI with the second priority, then the UCI with the first priority and the UCI with the second priority is multiplexed on the PUSCH with the second priority.

By multiplexing the UCI with the first priority and the UCI with the second priority on the PUSCH with the second priority, the transmission of the low-priority PUSCH and the high-priority UCI as well as the transmission of the low-priority UCI can be ensured.

### Example 2.3

Although not shown in the figure, there may be other scenarios.

For example, if there are a transmission of UCI with the first priority and a transmission of UCI with the second priority at the same time, and there are more than one PUSCHs with same or different priorities overlapping in time with the PUCCH transmitting with the first priority and the PUCCH transmitting the UCI with the second priority, then the PUSCH on which the UCI with the first priority and the UCI with the second priority are to be multiplexed is selected according to the predetermined rule describe above.

In addition, if there are transmissions of UCIs with more than two priorities, for example, there are transmissions of UCI with the first priority, UCI with the second priority, and UCI with the third priority, and there are more than one PUSCHs with same or different priorities overlapping in time with the PUCCH transmitting UCI, then the PUSCH on which the UCI with the first priority, the UCI with the second priority and the UCI with the third priority are to be multiplexed can also be selected according to the predetermined rule describe above. For simplicity of description, specific details will not be repeated.

### Example 2.4

Although not shown in the figure, there may be other scenarios.

For example, If there are a transmission of UCI with the first priority and a transmission of UCI with the second priority at the same time, and there is more than one PUSCH with same or different priorities overlapping in time with the PUCCH transmitting UCI with the first priority and the PUCCH transmitting UCI with the second priority, one PUSCH on which the UCI with the first priority and the UCI with the second priority are to be multiplexed can be also selected.

When the number of the priorities of UCI multiplexed on one PUSHC is more than one, a number of types of UCI can be limited in advance. Here, the types of UCI may include, but are not limited to, HARQ-ACK, CSI, and SR, and may also include other types of UCI. The maximum number (M) of types of UCI multiplexed on one PUSCH can be determined through signaling indication (for example, higher-layer signaling configuration or physical layer signaling indication) or protocol presets, wherein M is a positive integer.

In one example, UCIs belonging to a same type but with different priorities are considered to be UCIs of different types. For example, HARQ-ACK from the high-priority UCI and HARQ-ACK from the low-priority UCI are considered as UCIs of two types.

In the case of M equal to 3, when the PUCCH overlapping in time with the PUSCH includes high-priority HARQ-ACK, high-priority CSI, low-priority HARQ-ACK and low-priority CSI, there UCIs are selected therefrom to be multiplexed on the PUSCH. For example, high-priority HARQ-ACK, high-priority CSI and low-priority HARQ-ACK can be multiplexed on the PUSCH, while low-priority CSI can be discarded.

Alternatively, when the UCI with the first priority and the UCI with the second priority are simultaneously multiplexed on the PUSCH with the first priority, the UCI with the second priority can only include HARQ-ACK.

By limiting the number of types of UCI multiplexed on one PUSCH, the complexity of multiplexing UCI on the PUSCH can be controlled.

Hereinafter, a resource allocation method when multiplexing UCI on PUSCH will be described.

When UCIs with more than one priority are multiplexed on one PUSCH, the number and location of resources on PUSCH occupied by UCIs are determined in sequence according to the priority of UCI by the order from high to low, that is, the number and location of resources on PUSCH occupied by UCI with the highest priority is determined preferentially. For example, the number and location of resource on PUSCH occupied by UCI may be allocated through higher-layer signaling, physical layer signaling or protocols, or be notified by the base station using a separate signal as well.

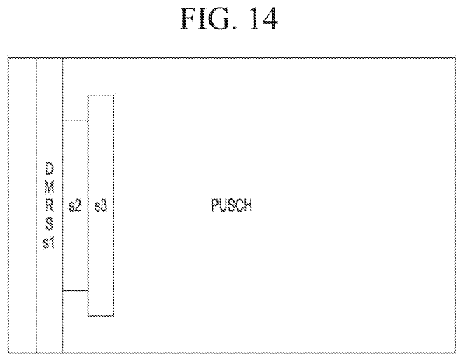

FIG. 13 shows a schematic flowchart of a method 1300 for allocating resources on PUSCH according to an embodiment of the present disclosure, and FIG. 14 shows a schematic diagram of resources allocated on PUSCH in the method of FIG. 13 according to an embodiment of the present disclosure. The method 1300 may be performed by the base station side.

For example, when the UCI with the first priority and the UCI with the second priority are multiplexed one PUSCH, at first, the number and location of resources on PUSCH occupied by the UCI with the first priority is determined, and then, the number and location of resources on PUSCH occupied by the UCI with the second priority is determined from among the remaining resources on PUSCH. That is, the number and location of resources on PUSCH occupied by the UCI with the first priority will not be affected whether the second priority UCI is multiplexed and by the number and location of resources on PUSCH occupied by the UCI with the second priority.

In the case that the HARQ-ACK from the UCI with the first priority and the HARQ-ACK from the UCI with the second priority UCI in a second priority are multiplexed on one PUSCH with the second priority, it is assumed that the total resources on the PUSCH are s, where the unit of s may be Resource Element (RE).

As shown in FIG. 13, at step S1301, resource s1 occupied by a demodulation reference signal (DMRS) and its location are determined.

At step S1302, the resource s2 occupied by the multiplexed HARQ-ACK from the UCI with the first priority and its position are determined from among the resource s-s1.

At step S1303, the resource s3 occupied by the multiplexed HARQ-ACK from the UCI with the second priority and its position are determined from among the resources s-s1-s2.

At step S1304, uplink data is transmitted on resources s-s1-s2-s3.

According to the embodiment of the present disclosure, by preferentially, determining the number and location of the resources on PUSCH occupied by the UCI with the highest priority, the transmission performance of the UCI with the first priority can be ensured, thereby preventing performance degradation caused by inconsistent understanding between the base station and the LTE on the resource occupied by the UCI with the first priority and its location, due to the error of bit number of the UCI with the second priority.

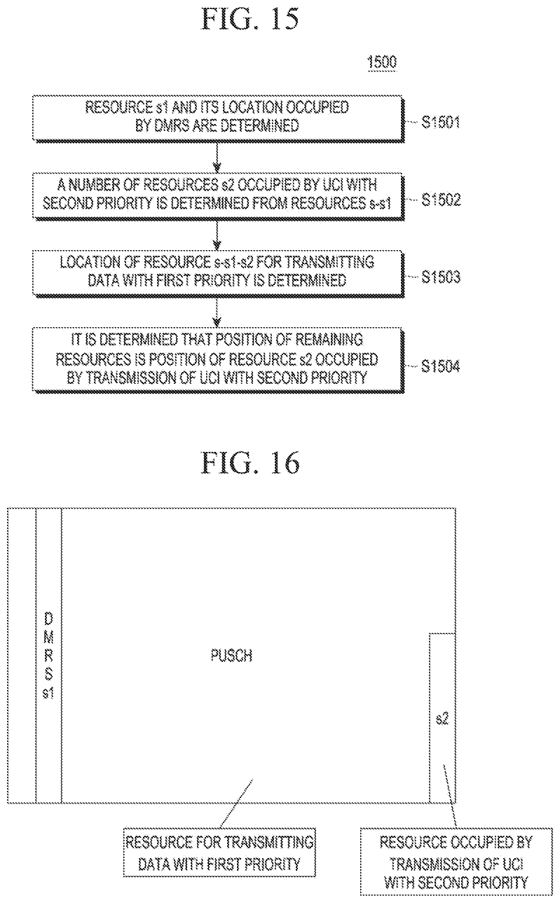

FIG. 15 shows a schematic flowchart of another method 1500 for allocating resources on PUSCH according to an embodiment of the present disclosure, and FIG. 16 shows a schematic diagram of resources allocated on PUSCH in the method of FIG. 15 according to an embodiment of the present disclosure. The method 1500 may be performed on the base station side.

When the low-priority UCI is multiplexed on the high-priority PUSCH, the location for transmitting data on the high-priority PUSCH is determined preferentially.

In the method 1500 shown in FIG. 15, it is assumed that the HARQ-ACK from the UCI with the second priority is multiplexed on PUSCH with the first priority and the total resource on the PUSCH is s.

As shown in FIG. 15, at step S1501, the resource s1 occupied by the DMRS and its location are determined.

At step S1502, the number of resources s2 occupied by the UCI with the second priority is determined from the resources s-s1. The number of remaining resources s-s1-s2 is for transmitting the data with the first priority.

At step S1503, the location of the resource s-s1-s2 for transmitting the data with the first priority is determined.

At step S1504, it is determined that the position of the remaining resources is the position of the resource s2 occupied by the transmission of UCI with the second priority.

Therefore, the transmission performance of the data with the first priority can be ensured, thereby preventing performance degradation caused by inconsistent understanding between the base station and the UE on the resource occupied by the data with the first priority and its location, due to the error of bit number of the UCI with the second priority.

The above description is directed to a dynamically scheduled PUSCH (DG PUSCH, Dynamic Grant PUSCH), and a method of configuration requested (Configure Grant, CG) PUSCH will be described below.

In one example, when the PUSCH with the first priority overlaps in time with the PUCCH transmitting the UCI with the second priority (UCI can be at least one of HARQ-ACK, SR, CSI, for example, UCI is HARQ-ACK) and when the PUSCH with the first priority is a configuration requested (Configure Grant, CG) PUSCH, the UCI with the second priority cannot be multiplexed on the PUSCH with the first priority, By transmitting the PUSCH with the first priority without transmitting the with the second priority, the transmission performance of the data with the first priority can be ensured, since when the transmission parameters of the first priority (for example, modulation and coding scheme (MCS), etc.) remain unchanged, multiplexing the UCI with the second priority on the PUSCH with the first priority will affect the performance of the data in the PUSCH with the first priority, while not multiplexing the UCI with the second priority on the PUSCH with the first priority can ensure the performance of the data in the PUSCH with the first priority.

Alternatively, when the PUSCH with the first priority overlaps in time with the PUCCH transmitting the UCI with the second priority (UCI can be at least one of HARQ-ACK, SR, CSI, for example, UCI is HARQ-ACK), when the PUSCH with the first priority is a configuration requested (Configure Grant, CG) PUSCH, and when the number of bits of the UCI with the second priority is less than or equal to P (P is a positive integer, configured by higher-layer signaling or preset by the protocol), the UCI with the second priority (UCI may be at least one of HARQ-ACK, SR, and CSI, for example, UCI is HARQ-ACK) can be multiplexed on the PUSCH with the first priority. By doing so, the advantage is that the balance can be achieved between ensuring the performance of the data in the PUSCH with the first priority and preventing the discarding of the UCI with the second priority.

Alternatively, when PUSCH with the first priority simultaneously overlaps in time with the PUCCH transmitting the UCI with the second priority and the PUCCH transmitting the UCI with the first priority, only the UCI with the first priority is multiplexed on the PUSCH with the first priority and the UCI with the second priority is not multiplexed on the PUSCH with the first priority; however, when PUSCH with the first priority merely overlaps in time with the PUCCH transmitting the UCI with the second priority, the UCI with the second priority can be multiplexed on the PUSCH with the first priority.

Alternatively, through independent protocol presets or higher-layer signaling configuration or physical layer signaling, the followings are indicated: whether only the UCI with the first priority, not the UCI with the second priority, is multiplexed on the PUSCH with the first priority, when PUSCH with the first priority simultaneously overlaps in time with the PUCCH transmitting the UCI with the second priority and the PUCCH transmitting the UCI with the first priority and when the PUSCH with the first priority is a configuration requested (Configure Grant, CG) PUSCH; and whether the UCI with the second priority can be multiplexed on the PUSCH with the first priority, when PUSCH with the first priority merely overlaps in time with the PUCCH transmitting the UCI with the second priority.

Alternatively, when PUSCH with the second priority simultaneously overlaps in time with the PUCCH transmitting the UCI with the second priority and the PUCCH transmitting the UCI with the first priority and when the PUSCH with the second priority is a configuration requested (Configure Grant, CG) PUSCH, whether the UCI with the first priority and the UCI with the second priority are multiplexed on the PUSCH with the second priority is indicated through independent protocol presets or higher-layer signaling configuration or physical layer signaling.

Alternatively, when the PUSCH with the first priority simultaneously overlaps in time with the PUCCH transmitting the UCI whit the second priority, and when the PUSCH with the first priority is a configuration requested (Configure Grant, CG) PUSCH, whether the UCI with the second priority (UCI can be at least one of HARQ-ACK, SR, CSI, for example, UCI is HARQ-ACK) can be multiplexed on the PUSCH with the first priority may be determined through independent higher-layer signaling configuration or protocol presets, the higher-layer signaling is referred as higher-layer signaling-1. That is, higher-layer signaling-1 is used to perform the configuration with respect to the scenario that: whether the UCI with the second priority can be multiplexed on the PUSCH with the first priority, when the PUSCH with the first priority is CG PUSCH. However, the followings are determined/configured by other signaling or physical layer signaling, not the higher-layer signaling-1: whether the UCI with the second priority (UCI can be at least one of HARQ-ACK, SR, CSI, for example, UCI is HARQ-ACK) can be multiplexed on the PUSCH with the first priority, when the PUSCH with the first priority is a DG PUSCH.

In addition, when the PUSCH with the first priority simultaneously overlaps in time with the PUCCH transmitting the UCI whit the first priority, and when the PUSCH with the first priority is a configuration requested (Configure Grant, CG) PUSCH, whether the UCI with the first priority (UCI can be at least one of HARQ-ACK, SR, CR, for example, UCI is HARQ-ACK) can be multiplexed on the PUSCH with the first priority may be determined through independent higher-layer signaling configuration or preset by protocols, the higher-layer signaling is referred as higher-layer signaling-2.

Alternatively, when the PUSCH with the second priority simultaneously overlaps in time with the PUCCH transmitting the UCI whit the first priority, and when the PUSCH with the second priority is a configuration requested (Configure Grant, CG) PUSCH, whether the UCI with the first priority (UCI can be at least one of HARQ-ACK, SR, CSI, for example, UCI is HARQ-ACK) can be multiplexed on the PUSCH with the second priority may be determined through independent higher-layer signaling configuration or preset by protocols, the higher-layer signaling is referred as higher-layer signaling-3.

Alternatively, when the PUSCH with the second priority simultaneously overlaps in time with the PUCCH transmitting the UCI whit the second priority, and when the PUSCH with the second priority is a configuration requested (Configure Grant, CG) PUSCH, whether the UCI with the second priority (UCI can be at least one of HARQ-ACK, SR, CSI, for example, UCI is HARQ-ACK) can be multiplexed on the PUSCH with the second priority may be determined through independent higher-layer signaling configuration or preset by protocols, the higher-layer signaling is referred as higher-layer signaling-3.

As such, the scheme for multiplexing UCI can be flexibly determined by the base station according to the requirements.

When the UCI with the first priority is multiplexed on the PUSCH with the second priority, if the required number (L) of resources (which can be the number of REs) is greater than the maximum number (L1) of resources defined by the threshold (the threshold can be configured through higher-layer signaling or preset by the protocols), then the number of resources is not limited by the threshold, and the UE can use resources greater than L1 to multiplex the UCI with the first priority. Here, the maximum number of resources defined by the threshold can be L1=alpha*(the number of all the RE on the PUSCH which can be used to transmit UCI), where alpha is a defined threshold, alpha is greater than 0 and less than or equal to 1. Alternatively, when the UCI with the first priority is multiplexed on the PUSCH with the second priority, if the required number (L) of resource is greater than the maximum number (L2) of resource defined by the threshold, the transmission of the PUSCH with the second priority can be cancelled, and the UCI with the first priority is transmitted through PUCCH. Here, the maximum number of resources defined by the threshold can be L2=beta*(the number of all the RE on the PUSCH which can be used to transmit UCI), where beta is a defined threshold, beta is greater than 0 and less than or equal to 1.

As such, under the premise of ensuring the performance of UCI with the first priority, the impact on the transmission performance of the PUSCH with the second priority can be reduced as much as possible.

When UCIs with different priorities are multiplexed on the PUSCH, the maximum number of resources that each UCI can occupy can be determined independently. For example, assuming that the number of REs on PUSCH that can be used for UCI transmission is L, the maximum number of resources that can be occupied by the UCI with the first priority is alpha_1*L and the maximum number of resources that can be occupied by the UCI with the second priority is alpha_2*L, where alpha_1 and alpha_2 can be independently configured by higher-layer signaling or preset by the protocols, alpha_1 represents the ratio of resources occupied by the UCI with the first priority, alpha_2 represents the ratio of resources occupied by the UCI with the second priority, 0<alpha_1≤1 and 0<alpha_2≤1.

As such, the performance of the UCI with the first priority can be ensured, while the performance of the UCI with the second priority can be ensured as much as possible.

When the UCI with the second priority is multiplexed on the PUSCH with the first priority, the maximum threshold of the resources occupied by the UCI with the second priority can be set. For example, assuming that the number of RE on the PUSCH can be used for UCI transmission is L and the maximum number of resources can be occupied by the UCI with the second priority is alpha*L, if the calculated number of resources is greater than the maximum number (alpha*L) of resources defined by the threshold, then a part of the UCI with the second priority can be discarded, so that the number of resources occupied by the UCI with the second priority is not greater than the maximum number (alpha*L) of resources defined by the threshold; or all the UCI with the second priority can be discarded. alpha represents the ratio of resources occupied by the UCI with the second priority, 0<alpha≤1.

As such, under the premise of ensuring the performance of the data with the first priority, the impact on the transmission of the UCI with the second priority can be reduced as much as possible.

When the UCI with the first priority and the UCI with the second priority are multiplexed on the PUSCH with the second priority, the maximum threshold of the total resources occupied by the UCI with the first priority and the UCI with the second priority can be set as well. For example, assuming that the number of RE on the PUSCH can be used for UCI transmission is L and the maximum number of resources can be occupied by the UCI with the first priority and the UCI with the second priority is alpha*L, where alpha is configured by higher-layer signaling or preset by the protocol, if the calculated number of resources is greater than the maximum number (alpha*L) of resources defined by the threshold, then a part of the UCI with the second priority can be discarded, so that the calculated number of resources is not greater than the maximum number (alpha*L) of resources defined by the threshold; or all the UCI with the second priority can be discarded. alpha represents the ratio of resources occupied by the UCI with the first priority and the UCI with the second priority, 0<alpha≤1.

In another example, when the UCI with the first priority and the UCI with the second priority are multiplexed on the PUSCH with the second priority, a maximum threshold of the total resources occupied by the UCI with the first priority and the UCI with the second priority as well as a maximum threshold of the resource occupied by the UCI with the first priority can also be set. For example, assuming that the number of RE on the PUSCH can be used for UCI transmission is L, the maximum number of resources can be occupied by the UCI with the first priority and the UCI with the second priority is alpha*L, and the maximum number of resources can be occupied by the UCI with the first priority is alpha_1*L, where alpha and alpha_1 are configured by higher-layer signaling or preset by the protocol, if the calculated number of resources is greater than the maximum number (alpha*L) of resources defined by the threshold, then a part of the UCI with the second priority can be discarded, so that the calculated number of resources is not greater than the maximum number (alpha*L) of resources defined by the threshold; or all the UCI with the second priority can be discarded. alpha represents the ratio of resources occupied by the UCI with the first priority and the UCI with the second priority, 0<alpha_1≤1 In addition, after all the UCI with the second priority is discarded, if the number of resources required by the UCI with the first priority is greater than the maximum number (alpha_1*L or alpha*L) of resources defined by the threshold, then the PUSCH with the second priority can be cancelled, the PUCCH is used to transmit the UCI with the first priority. alpha_1 represents the ratio of the resources occupied by the UCI with the first priority, 0<alpha_1≤1.

The parameters (for example, alpha) defined above for different scenarios can be the same parameters, or the parameters defined for different scenarios can be determined independently as well, for example, alpha configured when the UCI with the second priority is multiplexed on the PSUCH with the first priority and alpha configured when the UCI with the second priority is multiplexed on the PSUCH with the second priority may be independently determined.

As such, under a premise of ensuring the performance of the data with the first priority, the impact on the transmission of the UCI with the second priority can be reduced as much as possible.

Further, when UCIs of more than one priorities are multiplexed on the same PUSCH, for example, when the UCI with the first priority and the UCI with the second priority are multiplexed on the same PUSCH, at first, the number and location of the resource on the PUSCH occupied by the UCI with the first priority can be determined, and then, the information about the resource on which the UCI with the second priority is multiplexed may be indicated through indication information of the UCI with the second priority. The resource configuration of the UCI with the second priority, including the number and location of the occupied resources etc., can be predetermined, and the UE and the base station can know the detailed resource configuration scheme according to the index of the resource configuration. Therefore, the index of the resource configuration for the UCI with the second priority can be indicated by bits, as shown in Table 1 below. The UCI with the first priority UCI may include N bits, and the indication information of the UCI with the second priority may include M bits. For example, 2 bits are used to indicate four types of resource configurations for the UCI with the second priority, including the indication of no transmission of UCI with the second priority. Only four resource allocation schemes are shown in Table 1, but those skilled in the art can understand that fewer or more resource allocation schemes can be included.

TABLE 1

| | Number and location of the |
|---|---|
| Indication information | resource on PUSCH occupied by |
| of UCI with second priority | the UCI with the second priority |
| 00 | No transmission of UCI with |
| | the second priority |
| 01 | Resource allocation scheme 1 |
| | of UCI with second priority |
| 10 | Resource allocation scheme 2 |
| | of UCI with second priority |
| 11 | Resource allocation scheme 3 |
| | of UCI with second priority |

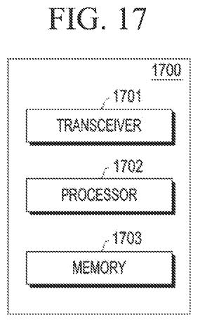

FIG. 17 shows a schematic block diagram of a device 1700 for transmitting data and control information according to an embodiment of the present disclosure. The device 1700 can be implemented on the UE side. For example, the device 1700 can be implemented to perform the method described above with reference to FIG. 5.

As shown in FIG. 17, the device 1700 may include a transceiver 1701, a processor 1702, and a memory 1703.

The transceiver 1701 transmits and receives signals. The memory 1703 stores instructions executable by the processor 1702, and the instructions when executed by the processor 1702, cause the processor 1702 to execute the method described above with reference to FIG. 5.

The above description is only a preferred embodiment of the present application and an explanation of the applied technical principles. Those skilled in the art should understand that the scope of the disclosure involved in this application is not limited to the technical solution formed by the specific combination of the above technical features, and should also cover other technical solutions formed by any combination of the above technical features or its equivalent features without departing from the inventive concept. For example, the a technical solution formed by replacing the above-mentioned features with the technical features disclosed (but not limited to) in this application with similar functions.

1. A method for transmitting, including:
receiving a multiplexing indication signal indicating multiplexing uplink control information (UCI) on a physical uplink shared channel (PUSCH);
multiplexing the UCI on the PUSCH; and
transmitting the multiplexed PUSCH,
wherein a number of priorities of UCI multiplexed on one PUSCH is at least one.

2. The method of claim 1, wherein the number of priorities of UCI multiplexed on one PUSCH is one, and the priority of UCI is the same as or different from the priority of PUSCH.

3. The method of claim 2, wherein multiplexing UCI with data includes:
on each of the multiple PUSCHs with different priorities, multiplexing UCIs with the same priority, respectively.

4. The method of to claim 1, wherein the number of priorities of UCI multiplexed on one PUSCH is more than one, and the priority of UCIs are the same as or different from the priority of the PUSCH.

5. The method of claim 1, wherein multiplexing UCI on the PUSCH includes:
when at least two physical uplink control channels (PUCCH) that transmit UCI with different priorities simultaneously overlap with PUSCH, preferentially multiplexing UCI with a higher priority among different priorities on the PUSCH.

6. The method of claim 1, wherein multiplexing UCI on the PUSCH further includes:
multiplexing UCIs with different priorities on multiple PUSCHs with the same priority, respectively; and
preferentially multiplexing UCI on PUSCHs with the same priority as that of the UCI.

7. The method of claim 6, wherein the PUSCH on which the UCI is to be multiplexed is selected from multiple PUSCHs according to a predetermined rule.

8. The method of claim 7, wherein when the multiplexed PUSCH is transmitted, a transmission power of the PUSCH, on which the UCI is multiplexed, is allocated decreasingly according to a decreasing order of the priorities of UCIs.

9. The method of claim 1, wherein when the UCIs with more than one priority are multiplexed on one PUSCH, a number and locations of resources on PUSCH occupied by UCIs are determined in sequence according to the priority of UCI by an order from high to low.

10. The method of claim 9, wherein when the UCI with a second priority is multiplexed on the PUSCH with a first priority, the position for transmitting data on the PUSCH with the second priority is determined preferentially, wherein the first priority is higher than the second priority.

11. The method of claim 9, wherein multiplexing the UCI on the PUSCH includes:
when the UCI with the first priority is multiplexed on the PUSCH with the second priority, multiplexing UCI with the first priority without being restricted by a resource threshold on the PUSCH with the second priority; or
when the UCI with the first priority is multiplexed on the PUSCH with the second priority, a physical uplink control channel (PUCCH) is used to transmit the UCI with the first priority, if the required resources exceed the resource threshold on the PUSCH with the second priority,
wherein the first priority is higher than the second priority.

12. The method of claim 9, wherein the maximum number of resources on the PUSCH occupied by the UCI is preset.

13. The method of claim 12, wherein the preset maximum number of resources on the PUSCH occupied by UCI includes at least one of:
a total maximum number of resources on the PUSCH occupied by all UCIs; and
a maximum number of resources on the PUSCH occupied by each UCI.

14. The method of claim 1, wherein the multiplexing indication signal is higher-layer signaling or physical layer signaling, and further indicates whether to multiplex UCI on a PUSCH with a priority different from that of the UCI.

15. A device for transmitting data and control information, the device including:
a transceiver configured to transmit and receive signals;
a processor; and
a memory in which instructions executable by the processor are stored, wherein the instructions, when executed by the processor, cause the processor to:
receive a multiplexing indication signal indicating multiplexing uplink control information (UCI) on a physical uplink shared channel (PUSCH);
multiplex the UCI on the PUSCH; and
transmit the multiplexed PUSCH,
wherein a number of priorities of UCI multiplexed on one PUSCH is at least one.
